(19) United States
(12) Patent Application Publication
(10) Pub. No.: US 2010/0268784 A1
(43) Pub. Date: Oct. 21, 2010

(54) DATA SYNCHRONIZATION SYSTEM AND METHOD

(76) Inventors: Marc Henness, Orlando, FL (US); Krzysztof Bartlomiej Baczkiewicz, Warszawa (PL); Pawel Ryszard Rogozinski, Warsaw (PL)

Correspondence Address: Daniel Law Offices, 37 N. Orange Ave., Suite 500, Orlando, FL, 32801, US

(21) Appl. No.: 12/762,072

(22) Filed: Apr. 16, 2010

Related U.S. Application Data
(60) Provisional application No. 61/212,879, filed on Apr. 17, 2009.

(51) Int. Cl. G06F 15/16

(52) U.S. Cl. 709/206

(57) ABSTRACT

A method and system for synchronizing data between a network of electronic devices comprising sending one or more messages in the form of a message sequence from a provider to a consumer, each message having descriptive data, a sequence identifier, and a sequence number, verifying by the consumer the presence, format, and continuity of each sequence identifier and sequence number in each message, and upon verification, updating the consumer with the descriptive data in each message.

### CROSS-REFERENCE TO RELATED APPLICATIONS

This application claims the benefit of U.S. application Ser. No. 61/212,879 filed on Apr. 17, 2009, the entire contents of which is fully incorporated herein by reference.

### RESERVATION OF RIGHTS IN COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Invention

The present invention relates generally to synchronization of data between electronic devices, and more particularly to a system and method for synchronizing data updates from a provider.

2. Description of the Related Art

In various types of environments, large amounts of data must be transferred between different environment components. The amount of information can be extremely large especially when the data is transferred from a multiple environment components. A reliable synchronization mechanism is required that is sufficiently strong so as to ensure the integrity and consistency of the data transferred between components of a network, but that is also adaptable to a variety of types of data messages. Moreover, the ability to allow differential data transfer is needed to enhance the performance efficiency of the environment components and the data transferred between them.

Previously, there are several types of methods for synchronizing data in client-server or peer-to-peer network environments. For instance U.S. Pat. App. Publ. 2007/0276836, describes a method for the synchronization of online and offline content, for example for purposes of source control. The method decentralizes the synchronization process by using universally unique identifiers (UUIDs) tied to each data object. However, each data set must be specially ordered and normalized, after which a protracted hashsum calculation must also be performed.

In U.S. Pat. No. 6,651,077 a backup and restoration method is disclosed that uses globally unique identifiers (GUIDs) in connection with database recovery forks, each fork representing a divergent path created during recovery and restoration of a database. However, the method must constantly maintain, track, and update a push-down stack of GUIDs associated with the backup and existing databases, and of log sequence numbers coupled to each GUID.

These and other previous approaches to synchronization of data in a network have utilized universally unique identifiers to track the integrity of databases for document backup, restoration, and source control. However, the inventive concepts described herein utilize a novel method for providing synchronized updates of information from a provider to a consumer without the complexity and inefficiency of the above described methods.

### SUMMARY OF THE INVENTION

The present invention is directed to a method and system for synchronizing data between a plurality of electronic devices. One embodiment of the present invention can include a system having a provider information unit for capturing information data relating to a provider and transmit the same in the form of one or more messages. The system can further include a communications network for transferring the message to a consumer which can validate the message, determine the message type, and store the information data in a database based on the received message type.

Another embodiment of the present invention can include full or differential messages which comprise varying degrees of information data.

Another embodiment of the present invention can include a method for performing the synchronization as described above.

### BRIEF DESCRIPTION OF THE DRAWINGS

Having thus described the invention in general terms, reference will now be made to the accompanying drawings, which are not necessarily drawn to scale, and wherein:

FIG. 1 is a first block diagram illustrating a system for providing synchronized differentials of data between electronic devices in accordance with one embodiment of the present invention.

FIG. 2 illustrates embodiments of a message in accordance with one embodiment of the present invention.

FIG. 3 is a flow chart illustrating a method for synchronizing data between a provider and a consumer in accordance with one embodiment of the present invention.

FIG. 4 is a flow chart illustrating a method for synchronizing data between a provider and a consumer in accordance with an alternate embodiment of the present invention.

### DETAILED DESCRIPTION

As will be appreciated by on skilled in the art, embodiments of the present invention may take the form of a system, method, or computer program product. Accordingly, the present invention may take the form of an entirely hardware embodiment, or an embodiment combining software (including firmware, resident software, micro-code, etc.) and hardware aspects that may all generally be referred to herein as a “circuit,” “module,” or “system.” Furthermore, an embodiment of the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example, but is not limited to, an electronic, magnetic, optical, electromagnetic, magneto-optical, infrared, or semiconductor system, apparatus, device, or propagation medium. More specific examples (a non-exhaustive list) of the computer-readable medium(s) would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, transmission media such as those supporting the Internet or an intranet, or a magnetic storage device.

The computer-usable or computer-readable medium may be paper or another suitable medium upon which the program is printed, as the program can be electronically captured via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, or transport the program for use by or in connection with the instruction execution system, apparatus, or device. The computer usable program code may be transmitted using any appropriate medium, including but not limited to wireless, wireline, optical fiber cable, radio frequency, etc.

Computer program code for carrying out operations of the present invention may be written in any combination of one ore more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods and computer program products in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. It will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowcharts block or blocks.

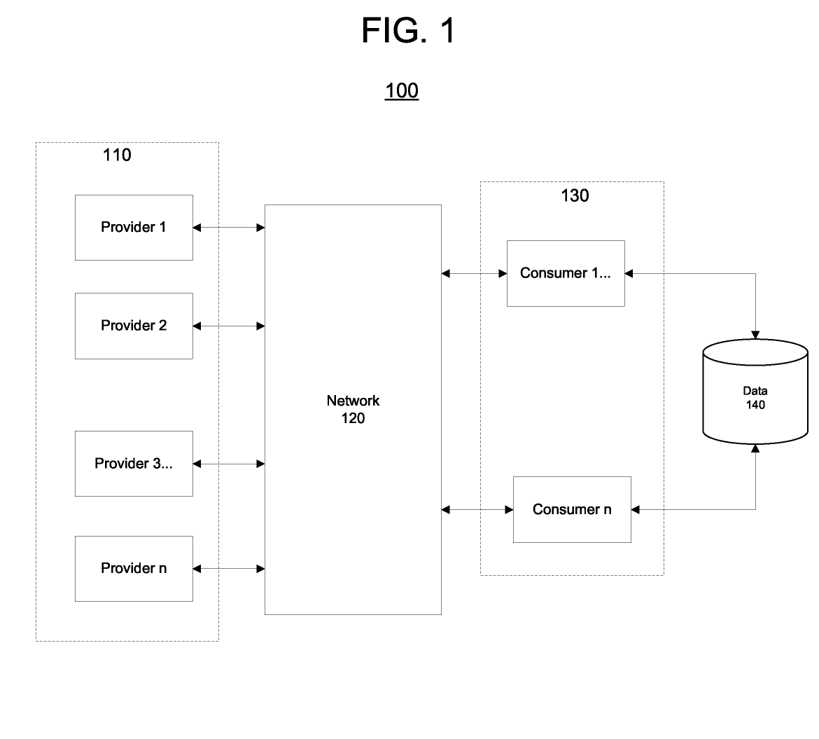

The embodiments described herein utilize a synchronization mechanism between providers and consumers of data. In one embodiment, a consumer can synchronize differential descriptive data sequences transmitted from a provider. For the purposes of simplicity the flowchart illustrations and block diagrams of FIGS. 1-4 depict one provider and one consumer. However, it should be noted that multiple providers and consumers may be used. Providers may be or reside on various physical machines, typically separate from the physical machine that is or contains the consumer. Consumers may also be or reside on various physical machines. In some instances, providers may also reside on or form a part of the same machine as the consumer. Multiple providers can independently and concurrently transmit data to a single consumer, and this data transfer may be performed asynchronously. Moreover, where environments require it, for example where the amount or throughput of data is relatively large, the pool of providers may be divided amongst more than one consumer. In any case, each provider can be assigned to one consumer and this assignment may be changed at any time, including during data transfer.

FIG. 1 is a first block diagram illustrating a system 100 for providing synchronized differentials of data between electronic devices in accordance with one embodiment of the present invention. To this end, system 100 can include one or more providers 110, a communication network 120, one or more consumers 130 and a database 140.

As used herein, a provider 110 can be a module located within a computer, a computer network or virtually any electronic device, capable of capturing information data (also referred to as descriptive data) associated with the device to which it is attached. For example, in one embodiment, a provider may capture inventory data relating to the internal components (hardware or software) of a particular network or machine. Alternatively, a provider may capture data relating to how the network or machine is used. In any case, this data is captured by the provider and organized into an individual message and/or message sequence for transmission to the consumer via the communications network. The provider may transmit each message automatically at a predetermined time period, or may be configured to transmit messages upon the occurrence of a particular event, such as the installation of new hardware in the network to which the provider is connected, for example. In any event, virtually any known transmission means can be utilized by the provider to transmit the information over the communications network.

The communication network 120 can be implemented as, or include, without limitation, a WAN, a LAN, the Public Switched Telephone Network (PSTN), the Web, the Internet, and one or more intranets. The communication network 120 further can be implemented as or include one or more wireless networks, whether short or long range, or mobile. Alternatively, in instances where the provider and consumer are located on the same device, the communications network can include a bus or other internal communication component which are well known in the art.

A consumer 130 can be a computer, a corporate computer network or other electronic device capable of communicating with the provider over the communications network. To this end, the consumer can receive messages transmitted by the provider 110. Upon receiving a message from the provider, the consumer can validate the message and provide the information data included within the message to the database 140. As will be described below in greater detail, this information data can consist of a complete data set or a partial data set depending on the result of the validation.

Database 140 can include any number of known storage devices. Although illustrated as a separate component, one of skill in the art will readily understand that the database can be included in the same machine, system or network as the consumer 130 and/or the provider 110.

In one embodiment, the provider 110, consumer 130 and/or the database 140 can be implemented as part of the EnterpriseAM Asset Management product, which is commercially available from Eracent® Corporation of Delaware. However, this is but one preferred example and is not intended to limit the scope of this document.

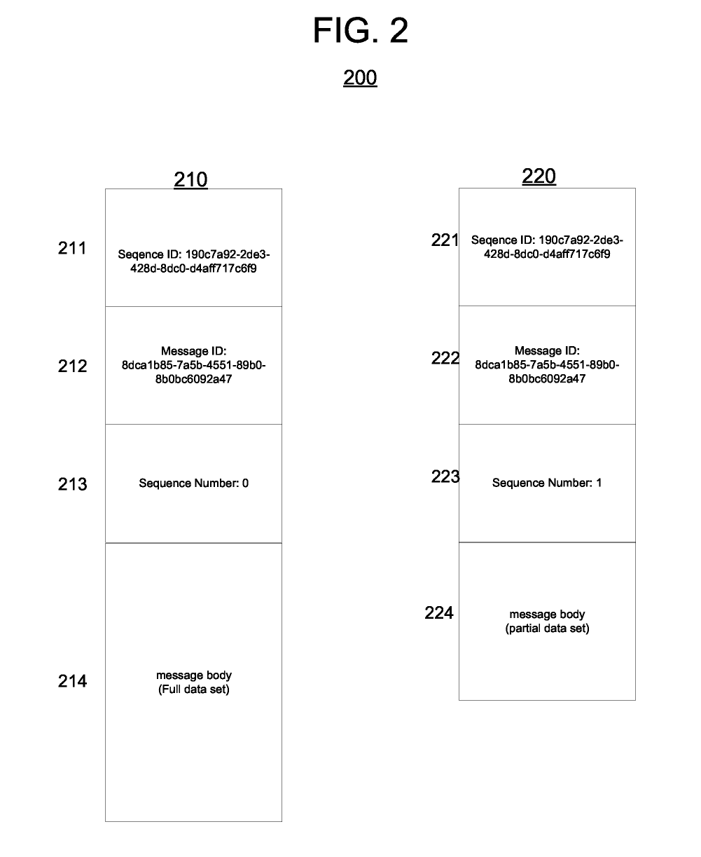

FIG. 2 illustrates one embodiment of a message sequence 200 for use with a provider and consumer as described above. As shown, a message sequence can consist of a plurality of individual messages. In any instance, each message will be one of two categories including: a Full message 210 and a Differential message 220. As used herein, a full message can include a complete accounting of all information data captured by the provider, whereas a differential message can include only partial information data. For example, in one embodiment, a differential message 220 can include only that data which has changed since the transmission of a previous message by the same provider. This new or changed data is called differential data. Owing to the fact that differential messages only transmit new or changed data, the provider must first transmit a full message to the consumer. Upon acceptance of the full message, the provider may send updates in the form of differential messages.

By sending updates in the form of differential messages, it is possible to greatly increase productivity by sparing network and computer resources from constantly transmitting receiving and storing redundant data.

As illustrated in FIG. 2, Full message 210 can include a sequence identifier 211, a message identifier 212, a sequence number 213 and a message body 214. The sequence identifier 211 and message identifier 212 can be of a globally unique identifier (GUID) type and can be created by any number of methods commonly known by those of skill in the art. The sequence number 213 can preferably be an integer, and is used to indicate the order of the differential messages inside a sequence. To this end, whenever a full message is transmitted by the provider to the consumer, the sequence number can be set to 0. This sequence number can then be increased by 1 each time a corresponding differential message in the same sequence (i.e. from the same provider) is transmitted.

As further shown in FIG. 2, Differential message 220 corresponds to full message 210. To this end, differential message 220 includes a sequence identifier 221, and a message identifier 222 which are identical to those of the full message 210. However, as this message is the first differential message in the sequence having only differential data 224, the sequence number 223 is increased by 1.

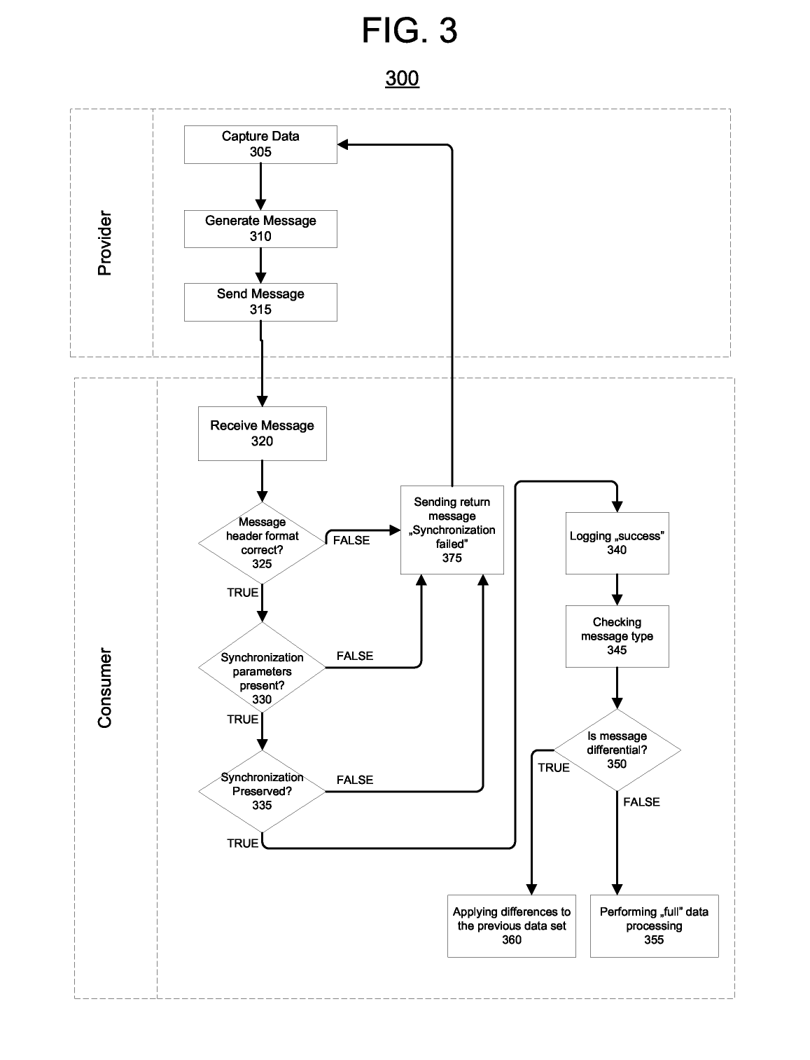

FIG. 3 is a flow chart illustrating a method 300 for synchronizing data between a provider and a consumer in accordance with one embodiment of the present invention. Method 300 can be implemented by a system as described with reference to FIG. 1. Accordingly, method 300 can begin in step 305 where the provider can capture information data. In step 310, this information data can be formatted into a message (for example a full message 210 or a differential message 220). In step 315, this message can be transmitted to the consumer.

In step 320 the message can be received by the consumer. In step 325, the format of the message can be checked. To this end, each GUID parameter can be unified to the same format and a determination can be made that each parameter of the message is in an accepted format thus ensuring data integrity. If the message header format is correct the method will proceed to step 330. However, if the message format is incorrect, the method will proceed to step 375 in which a “synchronization failed” message will be transmitted to the provider and the method will return to step 305.

In step 330, the consumer verifies the presence of each synchronization parameter or attribute expected to be detected in the header of the message. If an attribute or parameter is detected to be absent, the method will move to step 375 for transmission of the “synchronization failed” message, otherwise the method will proceed to step 335.

In step 335, the consumer verifies the continuity of the synchronization attributes or parameters by comparing that information with the information expected to be received to determine whether it is the same or different. For instance, if the message is a full message, the system will check to ensure the sequence number is 0. If the attributes are detected to contain different information than what is expected a false condition will result and the method will move to step 375. Otherwise the method will proceed to step 340 where the consumer can log the success of the synchronization check event.

Next, in step 345, the consumer can determine the type of message received by the provider. To this end, in decision step 350, the consumer can determine if the message sent by the provider is a differential message or a full message. If the message is determined to be a full message, the method can proceed to step 355 where the consumer can store the complete data set in a database. Alternatively, if the message is determined to be a differential message, the method can proceed to step 360 where the consumer can apply data change operations to the previous data set stored in the database.

Although not described in the figure above, in an alternate embodiment, the method can further communicate a “synchronization accepted” message or other similar communication. To this end, receipt of this acceptance message can alert the provider to send future sequence messages that contain only differential data.

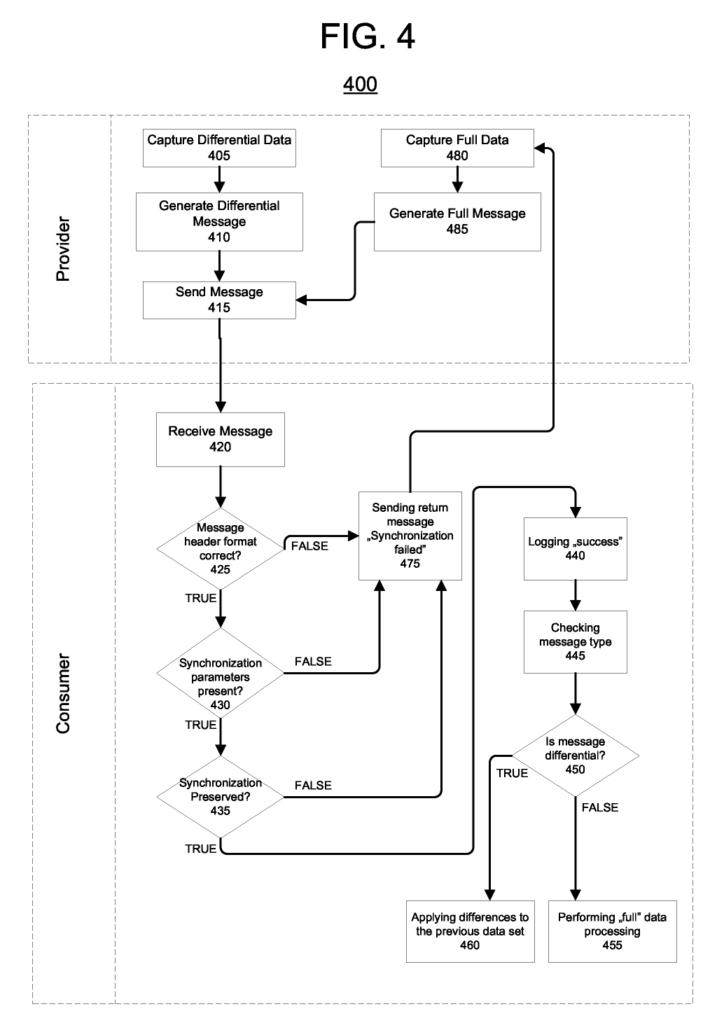

FIG. 4 is a flow chart illustrating an alternate method 400 for transmitting a message sequence from a provider to a consumer in accordance with one embodiment of the present invention. Method 400 can begin after full message has been transmitted to a consumer as described above in FIG. 3. Accordingly, method 400 can begin in step 405 where the provider can capture differential information data. In step 410, this information data can be formatted into a differential message (for example differential message 220) and transmitted to the consumer in step 415.

Method steps 420-465 proceed in much the same manner as that described with respect to FIG. 3. To this end, header and synchronization parameters are validated in steps 425-435, and if no errors are found, a message success is logged in step 440, and the database can be updated with the differential data contained in the message in steps 445-460.

However, when any of the header or synchronization preservation checks of steps 425-435 yield a false condition, the method will proceed to step 475 where a “synchronization failed” message will be transmitted to the provider. Upon receiving the synchronization message, the method will proceed to step 480 where the provider can capture a complete set of information data. Next, the method can proceed to step 485 where a full message (for example full message 210) can be generated. Upon creation of the full message, the method can return to step 415 where it can be transmitted to the consumer.

The aforementioned aspects of the present invention have wide ranging applicability. For example, the information technology assets of a company can be managed and tracked efficiently. An integrated software tool having the capabilities of the present invention may be used to inventory and discover the software and hardware assets throughout a corporate network. The tool may be used to identify and list each device on the network using a single, small-footprint program operating as the provider 10. Then the information kept by the provider 10 can be transmitted to a centrally located server, operating as a consumer 12, such as at an off-site storage facility, for storage and analysis. The efficiencies gained through the use of differential data transfer also prove beneficial when handling a large volume of data. Updates, such as changes in inventory and the like, may be sent from the provider 10 to consumer 12 to maintain the contents of a database without sending redundant information.

The flowchart and block diagrams in FIGS. 1-4 illustrate the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function or functions. It should also be noted that, in some alternative implementations, the functions noted in the block may occur out of order noted in the figures. For example, two blocks shown in succession may, in fact, be executed substantially concurrently, or the blocks may sometimes be executed in the reverse order, depending on the functionality involved. It will also be noted that each block of the flowchart illustrations, and combinations of blocks in the flowchart illustrations, can be implemented by special purpose hardware-based systems that perform the specified functions or acts, or combinations of special purpose hardware and computer instructions.

The foregoing description of embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

What is claimed is:

1. A system for synchronizing data between a plurality of electronic devices, said system comprising:
an provider information unit configured to capture information data relating to a provider and transmit said information in the form of one or more messages, each of said messages including a sequence identifier, a sequence number, a message identifier and the information data in the form of a message body;
a consumer unit configured to receive the message and determine a message type, said consumer unit being further configured to compare the sequence identifier and the sequence number provided in the message to a pre determined value;
a database configured to store the information data based on the message type; and
a communications network configured to transmit data between the consumer unit and the provider information unit.

2. The system of claim 1, wherein said message type includes one of a full message and a differential message, said full message including a complete set of information data, and said differential message including only data which has changed since a preceding message was sent by the provider.

3. The system of claim 2, wherein each differential message corresponds to a full message previously sent by the provider, and said full message and said corresponding differential message comprise a message sequence.

4. The system of claim 3, wherein each of said sequence identifier and message identifier are of GUID type,
said sequence number is an integer indicating an order of differential messages in a message sequence, and
each full message has a sequence number of zero.

5. The system of claim 4, wherein each differential message in a message sequence has the same sequence identifier and message identifier as the full message, and
the sequence number of each corresponding differential message is incremented by one.

6. The system of claim 2, wherein said consumer unit further includes
a communication module configured to send a return message to the provider information unit, said return message indicating the acceptance or rejection of each received message.

7. The system of claim 6, wherein in response to receiving a rejection message, said provider information unit is further configured to generate and transmit a full message having a complete set of information data to the consumer unit.

8. The system of claim 6, wherein in response to receiving an acceptance message, said provider information unit is further configured to determine the expiration of a pre determined period of time,
generate a new differential message that includes only data which has changed since the preceding message was sent to the consumer, and
transmit said new differential message to the consumer.

9. The system of claim 1, wherein said information data includes one or more inventory components on a client side computer network and,
said consumer unit is a part of a corporate computer network configured to receive the information data sent from the provider.

10. A method of synchronizing data between a plurality of electronic devices, said method comprising:
capturing, via a processor information data relating to a provider;
generating one or more messages that include at least one of a sequence identifier, a sequence number, a message identifier and the information data in the form of a message body;
sending, via a network, the one or more messages from the provider to a consumer;
comparing, via the consumer, the sequence identifier and the sequence number provided in the message to an expected value;
determining a message type corresponding to the received message; and
updating the database with the information data of the provider according to the determining.

11. The method of claim 10 wherein said message type includes one of a full message and a differential message, said full message including a complete set of information data, and said differential message including only data which has changed since a preceding message was sent by the provider,

12. The method of claim 11, wherein each differential message corresponds to a full message previously sent by the provider, and
said full message and said corresponding differential message comprise a message sequence.

13. The method of claim 12 wherein each of said sequence identifier and message identifier are of GUID type, and
said sequence number is an integer indicating an order of differential messages in a message sequence
wherein each full message includes a sequence number of zero.

14. The method of claim 13 wherein each differential message in a message sequence has the same sequence identifier and message identifier as the full message, and
the sequence number of each corresponding differential message is incremented by one.

15. The method of claim 11, further comprising:
sending a return message from the consumer to the provider indicating the acceptance or rejection of each message.

16. The method of claim 15, wherein in response to receiving a rejection by the consumer:
generating, via the provider, a full message having a complete set of information data.

17. The method of claim 15, wherein in response to receiving an acceptance by the consumer:
determining, via the provider, the expiration of a pre determined period of time; and
generating a differential message that includes only data which has changed since the preceding message was sent to the consumer.

18. The method of claim 10, wherein the provider is a module located on a client side computer network,
said information data sent from the provider describes one or more components on the client side computer network and,
the consumer is a part of a corporate computer network configured to receive the information data sent from the provider.

19. A system for synchronizing data between a plurality of electronic devices, said system comprising:
means for capturing information data relating to a provider and transmit said information in the form of one or more messages;
means for receiving the one or more messages at a consumer side;
means for determining a message type;
means for validating the received one or more messages;
means for storing the information data on the consumer side based on the message type; and
means for transmitting data between the means for capturing and means for receiving,
wherein each of said messages include a sequence identifier, a sequence number, a message identifier and the information data in the form of a message body, and said validating includes comparing the received sequence identifier and the sequence number provided in the message to a pre determined value.

20. The system of claim 19 wherein said message type includes one of a full message and a differential message, said full message including a complete set of information data, and said differential message including only data which has changed since a preceding message was sent by the means for sending.
